(19) United States
(12) Patent Application Publication
(10) Pub. No.: US 2019/0262766 A1
(43) Pub. Date: Aug. 29, 2019

(54) EMISSION CONTROL SYSTEM

(71) Applicant: Certified Pressure Testing LLC, Marietta, OH (US)

(72) Inventors: Oluwatosin A. OYELAKIN, Brooklyn, NY (US); Jeevan DAHAL, Houston, TX (US); Isaac SNYDER, Marietta, OH (US); Priyanka SHAHI, Houston, TX (US); Banchao SHU, Katy, TX (US)

(73) Assignee: Certified Pressure Testing LLC, Marietta, OH (US)

(21) Appl. No.: 16/286,236

(22) Filed: Feb. 26, 2019

Related U.S. Application Data
(60) Provisional application No. 62/635,260, filed on Feb. 26, 2018.

(51) Int. Cl. B01D 53/04; C10L 3/10

(52) U.S. Cl. CPC B01D 53/0462; C10L 3/101; C10L 3/104; C10L 3/103; B01D 2253/102; B01D 2256/24; C10L 2290/542; B01D 2257/504; B01D 2257/708; B01D 2259/402; B01D 2259/40003; B01D 2259/40007; B01D 2257/304

(57) ABSTRACT

An emission control system, comprising a plurality of vessels, each vessel an adsorbent arranged in the vessel; a valve system for selectively routing a feed stream to a selected vessel of the plurality of vessels thereby establishing an online vessel and one or more offline vessels; and a control unit configured for monitoring breakthrough of the online vessel and for controlling the valve system to route the emission an offline vessel upon breakthrough being determined in the online vessel, the routing establishing a new online vessel.

### CROSS-REFERENCE TO RELATED APPLICATIONS

The present disclosure claims priority to Provisional Application No. 62/635,260, entitled Emission Control System, and filed Feb. 26, 2018, the content of which is hereby incorporated by reference herein in its entirety.

### FIELD OF THE INVENTION

The present disclosure relates to capture and recovery of emissions. Particularly, the present disclosure relates to novel and advantageous systems and methods for capture and recovery of hydrocarbon emissions from a point source using an integrated unit performing adsorption, desorption, and condensation.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Emissions released during crude oil or natural gas exploration or productions have been a subject of concern throughout the world. Yet exploration of natural gas yields a significant portion of energy consumed and energy resources, at least in the U.S. As a result, natural gas exploration continues to rise using technologies such as down hole equipment, directional drilling, hydraulic fracturing, and developmental practices. While natural gas exploration continues to rise, this may present potential environmental risks due to the release of particulate matter, nitrogen oxides, sulfur dioxide, methane, volatile organic compounds, and/or other various hazardous air pollutants that may be emitted at different stages of the production process. These gasses may impair local air quality and consequently may have an effect on the overall health of people, particularly workers or residents in close proximity to drilling and production locations. Sources of air pollutants may include tank venting, flow back operations, pipelines for transmissions, pads during drilling, completion and separation of natural gas into components, and/or other sources.

Volatile organic compounds (VOCs) may also be released from oil and gas operations. VOCs are of particular interest as they are federally regulated and some studies have identified VOCs as probable carcinogenic substances. In addition to oil and gas activities, VOCs may be released from chemical, petrochemical, pharmaceutical, and/or other industries. Common examples of VOCs emitted from a variety of industrial sources may include benzene, toluene, ethylbenzenes, xylenes, methanol, and isopropyl alcohol.

Adsorption is one way in which VOCs are handled in emissions. The adsorption process may involve the use of a selective adsorbent in order to achieve good treatment and a desire results. The adsorbent of choice can be in granular, pellet or powdered form. Common adsorbents used for the treatment of VOCs include granular activated carbon fiber (ACF), zeolites, and polymers. However, the selected adsorbent may depend on the desired product targeted from the emissions stream. Industries have tried to manage VOCs with adsorption processes including thermal swing adsorption (TSA) and pressure swing adsorption (PSA). Thermal swing adsorption may need considerable time for its heating and cooling steps during regeneration. Thermal swing adsorption is still preferred to pressure swing adsorption because of its low cost for liquid recovery, purification, and drying. Carbon-based adsorbent is widely recognized for effective control and treatment of VOCs as well other trace pollutants in flue gas, because of its pore structure that creates a high affinity for the molecular size of the adsorbate of interest, its large surface area, and its relatively low affinity for moisture.

An adsorption system may be operated in a cycle and the complete cycle may be provided by a unit of the system. The emission stream containing the VOCs and other flue gas may pass through an adsorbent bed, where adsorption occurs, and the residual clean gas may be released to another system or to the environment. When the bed is saturated with the vapors, the bed may be put through a purification process, which can be a combination of various methods. In most cases the regeneration or the purification process are performed separately offsite or outside the adsorbent bed vessels.

Typically bed regeneration with TSA usually occurs at an elevated temperature greater than the adsorption. One recovery method for removing volatile organic compounds is using an adsorbent of activated carbon. In this method, activated carbon is commonly regenerated using superheated steam. Using steam in this process has several drawbacks. Steam causes potential pressure drawdown in the vessel and consequently leads to significant reductions in the recovery process. Typical bed regeneration processes usually include vapor desorption, followed by drying, and finally by cooling. During the desorption phase, steam may be provided to raise the temperature of the bed. Typically, the mixture of the VOC and the steam is then condensed, and then sent to a separator to remove the VOC from the steam. Using steam for regeneration makes the bed become wet and hot and consequently causes the bed to be unavailable for the next adsorption cycle. This is problematic for the application especially in a continuous feed stream where the vapor is continuously released and is in need of treatment.

Such conventional systems and methods for emission and VOC recovery often include process inefficiencies, such as low gas recovery due to mass transfer problems, a relatively large footprint, lack of automation, and high energy consumption. Thus, there is a need in the art for efficient emissions control systems and methods.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

An emission control system may allow for removal of uncontrolled emissions of vapor mixtures such as volatile organic compounds (VOCs), hydrogen sulfide, carbon dioxide and other inert gases from crude oil and natural gas production wells by, using adsorption, desorption and condensation processes. In at least one embodiment, the emission control system does not use steam for the removal of VOCs.

A stand-alone unit for purification and treatment of hydrocarbon emissions may be provided. The system may receive feed streams of a mixture of gases emitted from a point source, which may then come into the emission control system. A pair or more emission control vessels, in some embodiments, may be connected in parallel. In some embodiments, the emission control vessels may operated in a continuous cyclic manner where one may be online while the other is offline and the pair may take turns treating exiting gases while the others regenerate, for example.

The mixture of gases may be exposed to layers of a novel adsorbent of various forms. The adsorbent may be chemically impregnated and may be used to enhance molecular attraction of the gases emitted. VOCs, hydrogen sulfide and other inert gases may be accumulated on the adsorbent surface area as the gases pass through the vessel. The adsorption phase may be monitored until a specified or selected breakthrough point is observed (i.e., when the adsorbent is saturated, covered, or otherwise considered to be full, ineffective, or insufficiently effective). Upon breakthrough, an automated control system may switch a vessel from an adsorption process to a regeneration process for the bed. The timing of this may depend on the amount of VOC's or other reactive organic gases present in the treated gas. In one or more embodiments, breakthrough may occur after about 15 minutes, for example. In some embodiments, breakthrough may occur within about 20 minutes. In some embodiments, breakthrough may occur within 10 minutes. In some embodiments, breakthrough may occur in less than 45 minutes depending on the design, arrangement, or selection of one or more adsorption vessels. When one emissions control adsorption vessel is performing selective adsorption, the other vessel or vessels may be offline. When breakthrough is evident in the online vessel, the system may proceed to regeneration of the respective vessel, while another vessel performs adsorption.

The regeneration process for the bed may be initiated, in some cases automatically, as a result of a control system of the present disclosure. In some embodiments, the control system may control the in-vessel heat source to enhance the desorption of the VOCs and other gases from the adsorbent, and may subsequently control liquid recovery via condensation.

The systems and methods included herein with respect to at least some of the disclosed embodiments allow for efficiently controlling emitted vapors through adsorption, desorption and condensation. The system allows for a reduced system cycle time, which consequently leads to utilizing less power.

Embodiments of the present disclosure provide several advantages including generating liquid VOCs, recovery of natural gas, shorter cycle times, a generally automated process, a reduced footprint, a reduction in adsorbent requirement because of the regeneration of the bed, and improved treatment efficiency.

The present disclosure, in one or more embodiments, involves an adsorption process by a physio-chemical reaction conducted in an in-vessel thermal swing and regeneration vessel, creating an improved separation and recovery technique for hydrocarbon emissions streams. The system of the present disclosure, in one or more embodiments, integrates a non-steady state mathematical model with a thermal swing adsorption to provide a state of the art adsorption and/or desorption design that overcomes the inefficiencies associated with existing methods. The system may capture and recover organic vapors with a modified adsorbent and thermal regeneration. The system may separate higher molecular weight hydrocarbons from lighter ones.

The feed stream into the system may be from either the top or the bottom from the system. In at least one embodiment of the present disclosure, the feed stream enters the system from the top of the system. By having the feed stream enter from the top of the system, mass transfer is enhanced during regeneration and treatment efficiency can be improved over other systems where the feed stream enters from the bottom of the system.

In at least one embodiment, an emission control system comprises a plurality of vessels; a valve system for selectively routing a feed stream to a selected vessel of the plurality of vessels thereby establishing an online vessel and one or more offline vessels; and a control unit configured for monitoring breakthrough of the online vessel and for controlling the valve system to route the emission an offline vessel upon breakthrough being determined in the online vessel, the routing establishing a new online vessel. In some embodiments, the vessels comprise an adsorbent arranged in the vessel. The vessels may further comprise a heating element configured for selective heating of the adsorbent. In some embodiments, the control unit is further configured initiate a regeneration cycle for the formerly online vessel. In some embodiments, the feed stream is a fluid, emission gas, or other combusted fuel.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the principle and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of an emission control system of the present disclosure, according to one or more embodiments.

FIG. 2 is another perspective view of the emission control system of FIG. 1, according to one or more embodiments.

FIG. 3 is a top view of the emission control system of FIG. 1, according to one or more embodiments.

FIG. 4 is a front view of the emission control system of FIG. 1, according or more embodiments.

FIG. 5 is a side view of the emission control system of FIG. 1 according to one or more embodiments.

FIG. 6 is a schematic view of a vessel of an emission control system of the present disclosure during an adsorption phase, according to one or more embodiments.

FIG. 7 is a schematic view of a vessel of an emission control system of the present disclosure during a desorption and regeneration phase, according to one or more embodiments.

FIG. 8 is a piping and instrumentation diagram of an emission control system of the present disclosure for a storage tank application, according to one or more embodiments.

FIG. 9 is a piping and instrumentation diagram of an emission control system of the present disclosure for a wellhead application, according to one or more embodiments.

FIG. 10 is a data flow diagram for an emission control system of the present disclosure, according to one or more embodiments.

FIG. 11 is a data block diagram for the control unit of an emission control system of the present disclosure, according to one or more embodiments.

### DETAILED DESCRIPTION

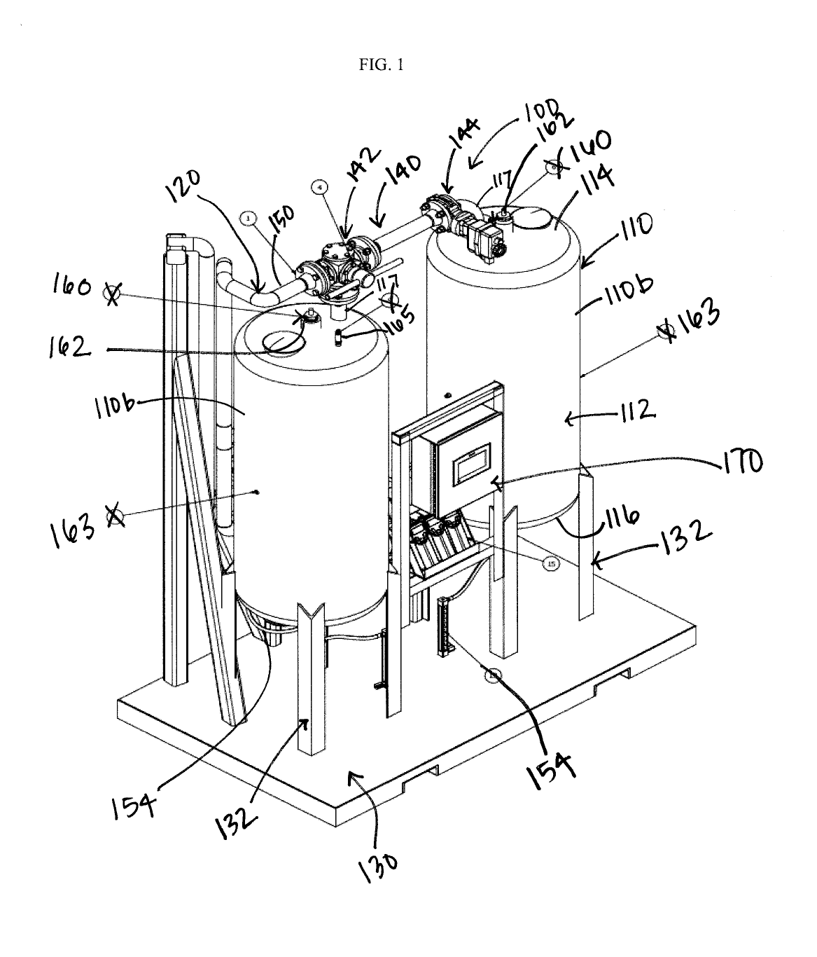

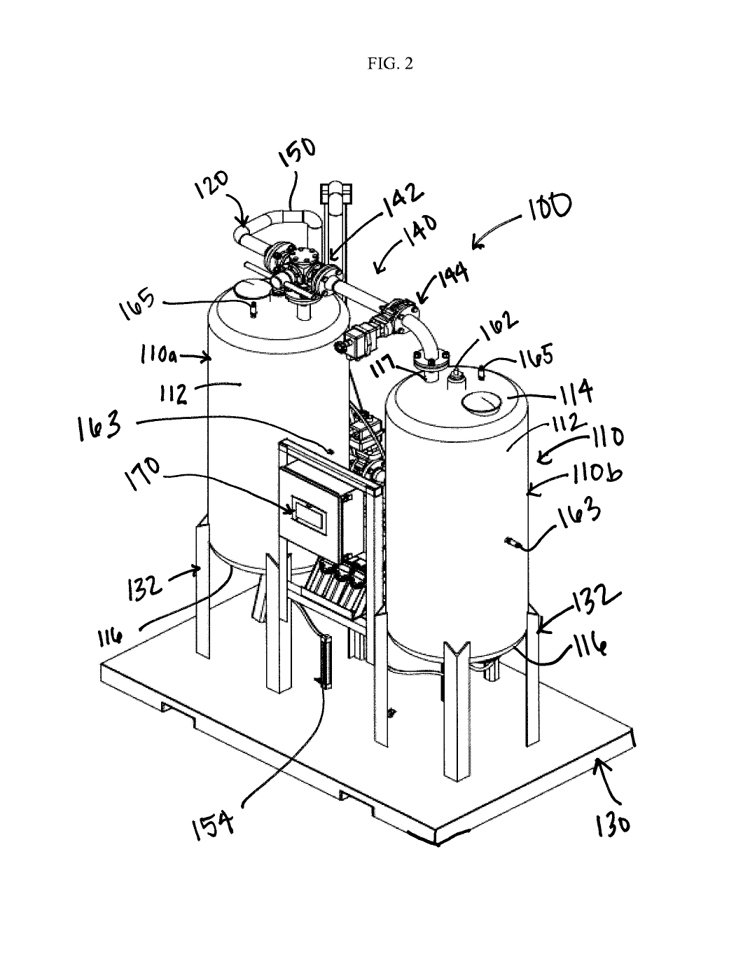

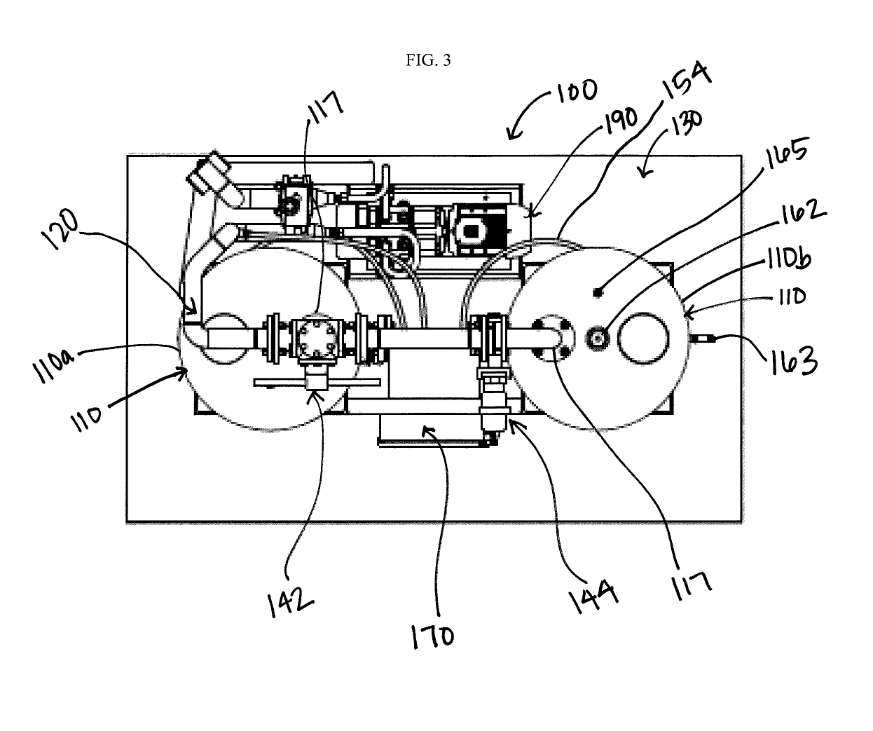

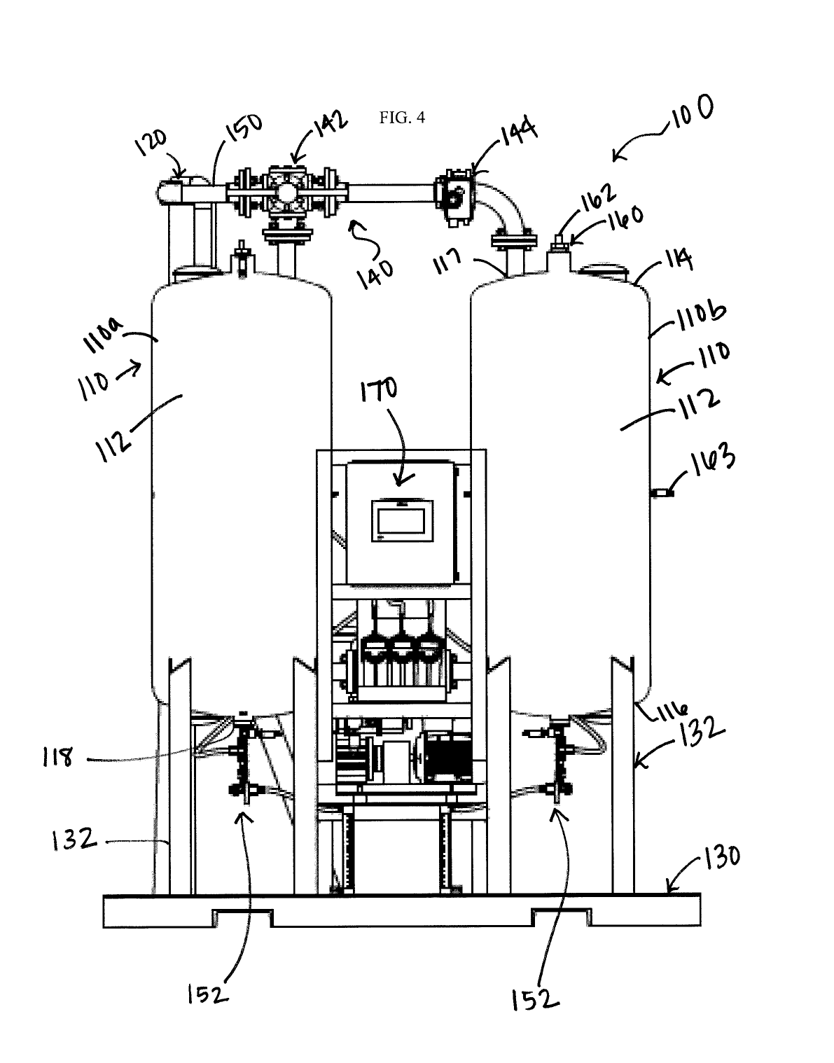

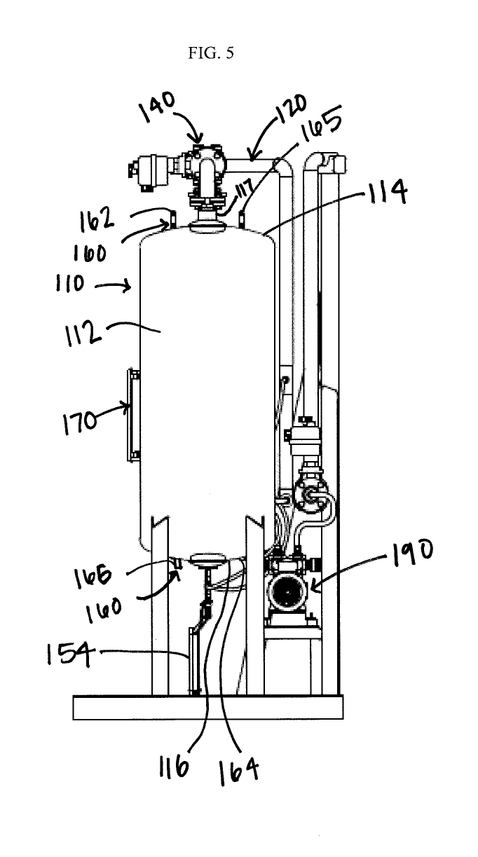

FIGS. 1-5 show an embodiment of emission control system 100 according to the present disclosure. The emission control system 100 comprises at least one adsorption vessel 110, a feed stream inlet 120, and a valve assembly 140. The valve assembly 140 may be connected to the feed stream inlet 120 and the at least one adsorption vessel 110 with piping 150. The feed stream inlet 120 may be connected to a fuel source such as a tank. In some embodiments, the adsorption vessel 110 may comprise a chamber 112 housing at least an adsorption bed. In some embodiments, the adsorption vessel 110 has a top 114 and a bottom 116. In some embodiments, the adsorption vessel 110 has a fluid inlet 117 near the top 114 and a fluid outlet 118 near the bottom 116. In some embodiments, the adsorption vessel 110 may be mounted to a base 130 with a mounting bracket 132. In at least one embodiment, the bottom 116 of the adsorption vessel 110 is connected to the mounting bracket 132.

In some embodiments, the emission control system 100 may comprise at least two adsorption vessels 110a, 110b connected to one another by at least the valve assembly 140. As shown, the feed stream inlet 120 may be positioned near the top 114 of the adsorption vessel 110. The feed stream inlet 120 may supply fuel, gas, or vapor from a fuel source to the at least one adsorption vessel 110 for emission control of the fuel source. In some embodiments, the valve assembly 140 may be connected to the feed stream inlet 120 and the at least one adsorption vessel 110 near the top 114 of the adsorption vessel 110. In some embodiments, the valve assembly 140 may comprise a plurality of valves. In some embodiments, the valve assembly 140 comprises as many valves as adsorption vessels. As shown in FIG. 1, there is a first adsorption vessel 110a and a second adsorption vessel 110b. The valve assembly 140 comprises a first valve 142 and a second valve 144. As shown, the first valve 142 may be connected to the first adsorption vessel 110a near the inlet 117. In some embodiments, the first valve 142 may be connected at or substantially near the top 114 of the first adsorption vessel 110a. In some embodiments, the first valve 142 comprises a three-way valve that is fluid communication with the feed stream inlet 112, the first adsorption vessel 110a, and the second adsorption vessel 110b. In some embodiments, the first valve 142 may comprise a pressure relief valve or other type of valve. As shown, the second valve 144 may be connected to the second adsorption vessel 110b near its inlet 117 and in fluid communication with the first valve 142. In some embodiments, the second valve 144 may be connected at or substantially near the top 114 of the second adsorption vessel 110b. In some embodiments, the second valve 144 comprises a two-way valve that is fluid communication with the first valve 142 and the second adsorption vessel 110b. In some embodiments, the second valve 144 may comprise a pressure relief valve or other type of valve. In some embodiments, each adsorption vessel 110 may have a second valve assembly 152 comprising one or more valves connected to the outlet 118. The second valve assembly 152 of at least the second adsorption vessel 110b may be connected to a feed outlet 154. In some embodiments, the second valve assembly may be disposed within the mounting bracket 132 beneath the adsorption vessel 110.

In some embodiments, each adsorption vessel 110 may comprise one or more sensors 160 for sensing at least one of temperature or pressure. In at least one embodiment, the adsorption vessel 110 has a first temperature sensor 162 near the top 114 of the adsorption vessel 110, a second temperature sensor 163 between the top 114 and the bottom 116 of the adsorption vessel, and a third temperature 164 near the bottom 116 of the adsorption vessel. The first temperature sensor 162 may be used to measure the temperature of influent vapor. The second temperature sensor 163 may be used to measure temperature for the adsorption bed within the adsorption vessel 110. The third temperature sensor may be used to measure the temperature of effluent vapor. In at least one embodiment, the adsorption vessel 110 has a first pressure transducer 165 near the top 114 of the adsorption vessel 110 and a second pressure transducer 166 near the bottom of the adsorption vessel 110. The first pressure transducer 165 may be used to measure the pressure of influent vapor. The second pressure transducer 166 may be used to measure the pressure of effluent vapor. In some embodiments, the sensors may further comprise valve sensors, heater cartridge sensors, and mass flow sensors.

In at least one embodiment, the system may further comprise a control unit 170 such as a programmable logic controller connected to one or more of the adsorption vessels. The control unit 170 may be provided with a transport phenomenon program and an embedded mathematical model. The control unit 170 may receive real time information during the treatment process and may make predictions of the mass and energy balance accuracies. Accordingly, mass and energy balances of the system may be readily available. The sensors 160 may be in communication with the control unit 170. In at least one embodiment, the control unit 170 may receive one or more signals from the sensors 160. The signals may be analog signals, pulse signals, or digital signals. In some embodiments, signals may be provided to the control unit 170 using digital Modbus communications. These signals may be processed by the control unit 170 to provide an output to direct a range of control operations including, but not limited to, electrically actuated valve opening or closing, on and off control modes for the heater cartridge, and data logging from a monitoring device such as a flowmeter or emissions monitoring devices such as VOC and non-VOC sensors. Where the sensors include a heater cartridge sensor, data from the heater cartridge sensor may be used to raise the temperature of the adsorption bed during desorption. Data from the temperature sensors may be used to control when the system switches from an adsorption stage to a desorption stage. In some embodiments, temperatures within the system may be maintained with a temperature controller. In some embodiments, valve sensors may send signals to the control unit 170 that may be used to control whether the valve is open or closed. In some embodiments, data from emissions monitoring devices may be used to monitor influent and effluent concentrations of vapors. When breakthrough occurs, the control unit may trigger a valve to close and/or trigger the temperature controller to moderate the bed temperature to a preset value for one or more of the adsorption vessels.

In some embodiments, the control unit 170 may comprise an interface displayed to a user at or near the control unit or accessible remotely on a device such but not limited to a computer, smartphone, or tablet. In some embodiments, the interface may comprise an app provided on both iOS and Android devices, or other suitable device. Alternatively, the control unit may be connected to a user device via a network. For example, the control unit 170 may be connected to a user device via direct connection to the device using the provided “Remote Operator” software, which essentially duplicates the control unit, providing full functionality of the control unit. In some embodiments, the control unit 170 can also act as a webserver, providing access via a web browser. With the proper URL and login credentials, the PLC can be access with full functionality. In some embodiments, the control unit 170 may be connected to a database, providing real time data recording to a dedicated server. In some embodiments, the control unit 170 may act as the central hub for all communications, computations, inputs, outputs, and control functions. For digital communications, the control unit may include one or more built in ports such as an RJ-45 port for Ethernet communications, and an RJ-12 port for RS-485 connections. In some embodiments, Modbus communication protocol can be used on both ports. For analog, pulse, and discrete signals (On/Off) the 170 may include an additional module that connects to the control unit 170 such as by snapping onto the back of the control unit 170. In some embodiments, a central processing unit is connected to the control unit 170, for example by snapping onto the back of the control unit 170. In some embodiments, the control unit 170 may a touchscreen Human Machine Interface (HMI). With this display, data can be monitored locally in real time. An operator can cycle through information via the HMI and submit manual control changes. Analog signals may be wired into predetermined inputs on the snap in module. Consequently the module may convert the analog signal into a digital signal that is linearized to the process instruments appropriate calibrated scale. Pulse signals may be calibrated in pulses per measured unit. Like analog signals, the control unit 170 may read those pulses and the result may be linearized to the process instruments appropriate calibrated scale. Digital signals read by the control unit 170 may not need to be modified or converted. The control unit 170 may point to the appropriate Modbus register of the instrument and request the measured variable. When communication between the devices are confirmed, the instrument may send the requested variable back to the control unit 170.

In some embodiments, a pump assembly 190 may be provided in fluid communication with the feed inlet 120. In other embodiments, a pump assembly 190 may comprise a heat exchanger in fluid communication with outlets from the second valve assembly 152.

Embodiments of the present disclosure provide for monitoring adsorption breakthrough by processing all the monitored parameters such as, temperature, pressure, flowrate and concentration as input into the developed control algorithm in the control unit, which in some embodiments depending on the signals provided from the sensors automatically closes at least the first valve 142 at a low percentage of breakthrough of the VOC. The adsorption phase may be considered complete when the breakthrough is determined and the first valve 142 is closed. It is noted that the control unit may monitor and determine breakthrough in at least two ways. First, the control unit 170 may monitor the concentrations of particular gases flowing out of the vessel and where a new gas shows up on the effluent monitor, particularly a gas that is present at the influent, but over a period of time has not been sensed at the effluent, breakthrough may have begun to occur. Second, the control unit 170 may estimate when breakthrough is going to occur or is about to occur based on information about the influent concentration, the flowrate, and the adsorbent rate and capacity. This latter approach may be relatively accurate, particularly when the heat of the adsorbent is considered.

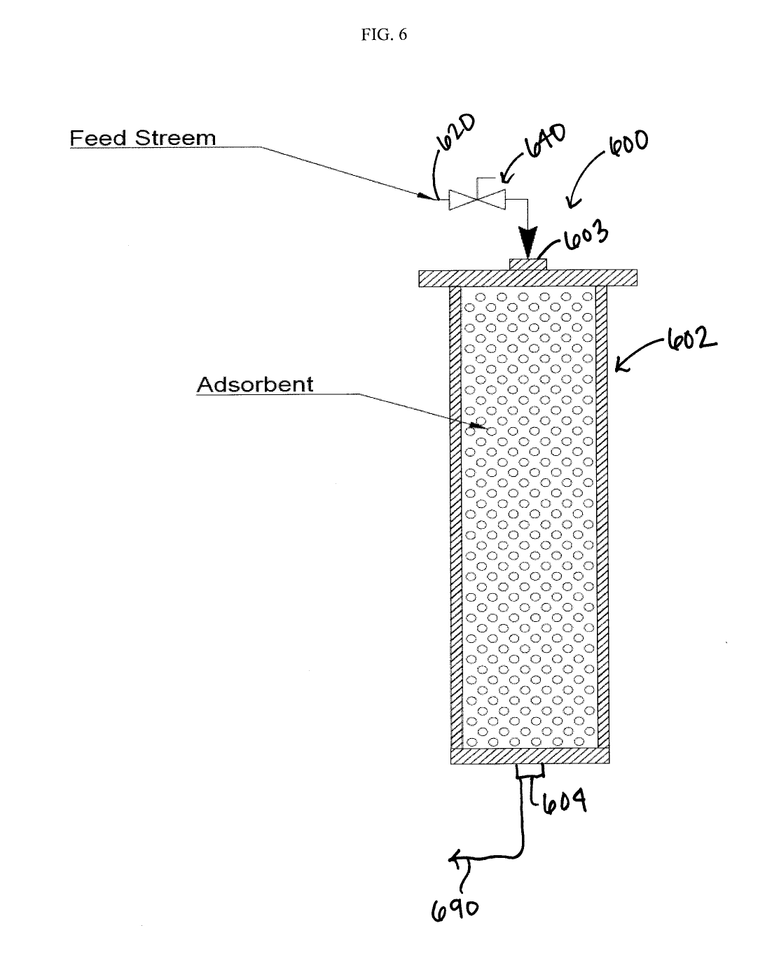

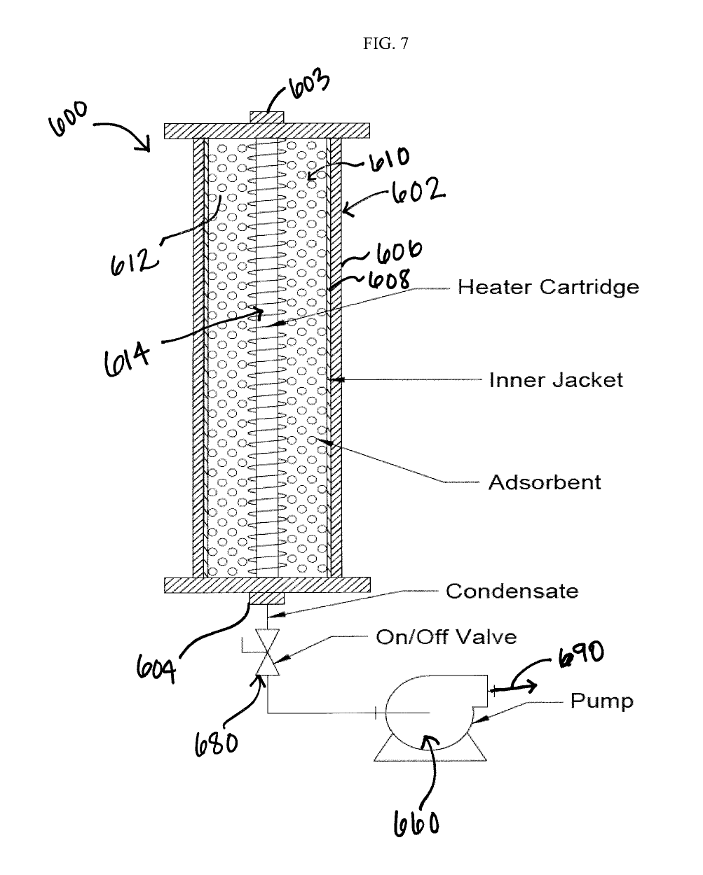

Schematics of a system 600 of the present disclosure during adsorption and desorption are shown in FIGS. 6-7. FIGS. 6-7 shows the system 600 comprising adsorbent vessel 602 having an inlet 603 and an outlet 604, the feed stream inlet 620, the valve 640 in fluid communication with the feed stream inlet 620 and the inlet 602 of the adsorbent vessel 600, a pump or compressor 660, a valve 680 in fluid communication with the outlet 604 of the adsorbent vessel 600 and the pump 660, and an exit line 690. The adsorbent vessel 602 comprises at least an outer shell 606. In some embodiment, portions of an inner surface of the outer shell 606 is lined with an inner layer 608. The inner layer 608 may be an insulative layer. In some embodiments, the outer shell 606 and/or the inner layer 608 define a chamber 610 in which an adsorbent bed 612 is disposed. A heater cartridge 614 may be disposed within the chamber. As vapor from a fuel source or tank connected to the feed stream inlet 620 enters the adsorbent vessel 600 and is exposed to the adsorbent, adsorption of the vapor starts to occur because of the weak intermolecular force of attractions between the higher molecular weight components (VOCs) and the adsorbent, resulting in physical adsorption of the heavier compounds. However, the lighter hydrocarbon containing natural gas may mostly pass through the adsorbent bed 612 as effluent to the compressor 660 and may exit the system through the exit line 690. FIG. 7 shows generally the desorption or regeneration phase, which may occur after the end of the adsorption phase. During the desorption step, the vapor may be desorbed, in one embodiment, by raising the temperature from about 20-25° C. at the end of the adsorption phase to a temperature at a temperature of about 150° C. The heater cartridge 614 disposed within the chamber may be used to heat the adsorbent bed 612. The heater cartridge 614 may be powered electrically. The temperature may be controlled by a controller to moderate the temperature. As the temperature of the adsorbent bed increases from the adsorption temperature, the pressure of the vapor may increase, and the volume of gas may agglomerate within minutes to condense the gas into a liquid which may pass through the outlet 604 to the valve 680. In some embodiments, the temperature of the pump or condenser 660 may be monitored. In at least one embodiment, the temperature of the pump or condenser 660 set to about 20° C.+/−5° C. to ensure that it does not change by the time agglomerate desorbed vapor moves into the condensation unit. The condenser, which may be a heat exchanger, enhances the mass transfer of the vapor into liquid due to the temperature differential of the desorbed vapor coming into the pump or condenser 660 and the temperature of the pump condenser 660. The resulting liquid, may be collected from the exit line 690 into a container. The liquid recovered may be analyzed by a gas chromatography analyzer to account for the mass of adsorbate recovered in liquid form.

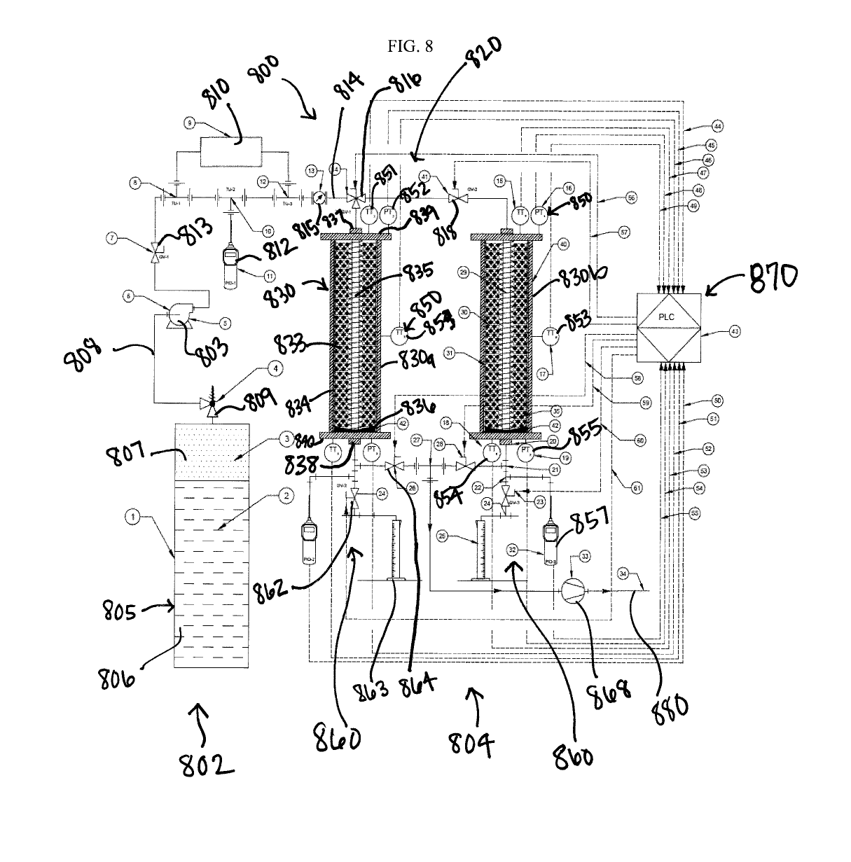

FIG. 8 is a fluid diagram of an emission control system 800 of the present disclosure for use with a fuel storage tank. The emission control system 800 comprises a storage tank assembly 802 and an adsorption assembly 804 connected to the storage tank assembly 802. The storage tank assembly 802 may comprise a tank 805 containing a fuel source such as oil or gas 806 and emitted vapors 807. The storage tank assembly 802 may further comprise a centrifuge pump 807 in fluid communication with the tank 805 by way of fuel line 808 for transmitting the feed stream within the system. In some embodiments, a pressure relief valve 809 may be positioned along the fuel line 808 between the tank 805 and the pump 807. In some embodiments, the storage tank assembly 802 may comprise at least one of a gas analyzer 810 and a VOC sensor 812 for analyzing influent vapor in the feed stream. The gas analyzer 810 may be used to monitor non-VOCs. In some embodiments, a valve 813 may be positioned along the fuel line 808 between the pump 807 and the one or more of the gas analyzer 810 and the VOC sensor 812 to provide data regarding the VOCs or other compounds in the feed stream prior to adsorption.

When the vapor builds up inside tank 805, and it reaches a threshold for control, the pressure relief valve 809 may open and trigger the pump 807 to operate. The 813 may be controllably opened or closed to allow the vapor to flow to one or more of the gas analyzer 810 and the VOC sensor 812. The gas analyzer 810 may monitor the lower hydrocarbon vapor concentrations and speciation, while VOC sensor may monitor the heavier hydrocarbon component concentrations in the same vapor mixture. The respective abilities of the analyzers 810, 812 to draw vapor to themselves is possible due to an embedded suction pump incorporated with the analyzers.

In at least the embodiment shown, the adsorption assembly 804 is configured for thermal swing adsorption. The adsorption assembly 804 comprises a feed inlet 814, an inlet valve assembly 820, one or more adsorption vessel assemblies 830, and a control unit 870. In at least one embodiment, a digital mass flow meter 813 may be positioned between the storage tank assembly 802 and the feed inlet 814 to monitor the vapor flow rate in real time. The feed inlet 814 is connected to the fuel line 808 and receives the feed stream from the storage tank assembly 802. The feed inlet 814 is in fluid communication with an inlet valve assembly 820. The inlet valve assembly 820 comprises a first valve 816 connected to a first adsorption vessel assembly 830a and at least a second valve 818 connected to a second adsorption vessel assembly 830b. There may be as many valves in the inlet valve assembly 820 as there are adsorption vessel assemblies 830 in the adsorption assembly 804. The first valve 816 may be in fluid communication with the feed inlet 814, the first adsorption vessel assembly 830a, and the second valve 818. The first valve 816 may be in electronic communication with the control unit 870 to open, close, or otherwise operate the valve 816. The second valve 818 may be in fluid communication with the first valve 816 and the second adsorption vessel assembly 830b. The second valve 818 may be in electronic communication with the control unit 870 to open, close, or otherwise operate the valve 818. When the valves 816, 818 are in the open position, the feed stream can enter the adsorption vessel assemblies 830a, 830b for processing.

As shown in FIG. 8, the two vessel assemblies 830a, 830b are connected in parallel, but the vessels assemblies 830 may be connected in any number and in any configuration suitable for any one of the emission control methods described in this application. The one or more adsorption vessel assemblies 830 comprise an adsorption vessel 832, a plurality of sensors 850, and an exit valve assembly 860 in communication with an exit line 880. The adsorption vessel 832 comprises an adsorption bed 833 disposed within a chamber of the adsorption vessel. The adsorption vessel may be comprised of stainless steel. The adsorption vessel may further comprise at least an inner layer 834 and a heater cartridge 835 suspended within the vessel 832. In at least one embodiment, the inner layer 834 may comprise stainless steel wire gauze or other suitable material. The inner layer 834 may provide space for the heater cartridge 835 to be suspended within the vessel 832. In at least one embodiment, a support layer 836 may be placed below the adsorbent bed 833. The support layer 836 may comprise fiberglass, insulative plastics, polymers, ceramics, or other insulative materials. The adsorption vessel 832 may have an inlet 837 and an outlet 838. The inlet 837 may be positioned at or substantially near the top 839 of the adsorption vessel 832. The outlet 838 may be positioned at or substantially near the bottom 840 of the adsorption vessel 832. The inlet 837 of the adsorption vessel may be in fluid communication with the inlet valve assembly 820. The outlet 838 may be in fluid communication with the exit valve assembly 860.

A plurality of sensors 850 may be provided to obtain information regarding pressure, temperature, VOCs, and other parameters for monitoring the feed stream. The plurality of sensors 850 may include, but are not limited to, a temperature sensor 851 for the influent vapor, a pressure transducer 852 for the influent vapor, a temperature sensor 853 for the adsorption bed 883, a temperature sensor 854 for the effluent vapor, a pressure transducer 855 for the effluent vapor, and at least one VOC sensor 857. Each of the sensors 850 may be in electronic communication with the control unit 870 to provide feedback from the adsorption vessel assembly. In some embodiments, the sensors for measuring parameters for the influent vapor, such as temperature sensor 851 and pressure transducer 852, may be positioned near the inlet 837. In one embodiment, sensors 851, 852 are positioned at or near the top 839 of the adsorption vessel 832. The sensors for measuring parameters for the effluent vapor, such as temperature sensor 854 and pressure transducer 855, may be positioned near the outlet 838. In one embodiment, sensors 854, 855 may be positioned at or near the bottom 840 of the adsorption vessel 832. In some embodiments, the sensors for measuring parameters for the adsorption bed may be positioned between the inlet 837 and the outlet 838. In some embodiments, the sensors for measuring VOC levels may be positioned in communication with the exit valve assembly 860.

The exit valve assembly 860 may comprise one or more valves 862, 864. In at least one embodiment, the valves 862, 864 are in electronic communication with the control unit 870 to open, close, or otherwise operate the valves. In at least one embodiment, the valve 862 is in fluid communication with the adsorption vessel 832 and a flask 863 for collecting effluent liquid for analysis. In at least one embodiment, the valve 864 is in fluid communication with the adsorption vessel 832 and the exit line 880. In at least one embodiment, a pump or condenser 868 may be positioned between the exit valve assembly 860 and the exit line 880.

Based on information received at least from the plurality of sensors 850, the control unit 870 may provide feedback to control one or more of the valves of the inlet valve assembly 820, one or more of the valves of the exit valve assembly 860, and/or the temperature of the heater cartridge 832. By doing so, the control unit 870 helps control the adsorption process and the desorption and/or regeneration process. The control unit may also receive data from the gas analyzer 810 and the VOC sensor 812 of the storage tank assembly. The control unit 870 may also receive information from the digital mass flow meter 813. With the information received from one or more of the gas analyzer 810, the VOC sensor 812, and the mass flow meter 813, the control unit may be able to compute the emission rate of the vapor released from the fuel stored within the tank.

In some embodiments, the first valve 816 may be open to allow vapor to the first vessel assembly 830a when the first vessel is performing adsorption and when the second vessel assembly 830b is operating for adsorption, the first valve 816 may open to the second valve 818, which opens to vessel assembly 830b. Accordingly, whichever of valves 816, 818 is open is an indication that the vessel assembly is operating. The opening and closing of the gate valves may be performed through the control algorithm developed and embedded in the control unit.

In-vessel thermal swing adsorption may occur in four different modes. Initially both of the adsorption vessel assemblies 830a, 830b are offline during the emission monitoring. Following emission monitoring, adsorption may be required along with regeneration of the vessel assemblies and liquid recovery. In the online mode, the vapor stream exits from the mass flow meter 813 and enters the first vessel assembly 830a. The inlet from the top of the vessel may be directly linked to the inner layer 834. The adsorbent bed may contain a modified granular carbon based adsorbent. The ability of the vapor to concentrate on the surface of the adsorbent may be by way of a process called enhanced adsorption.

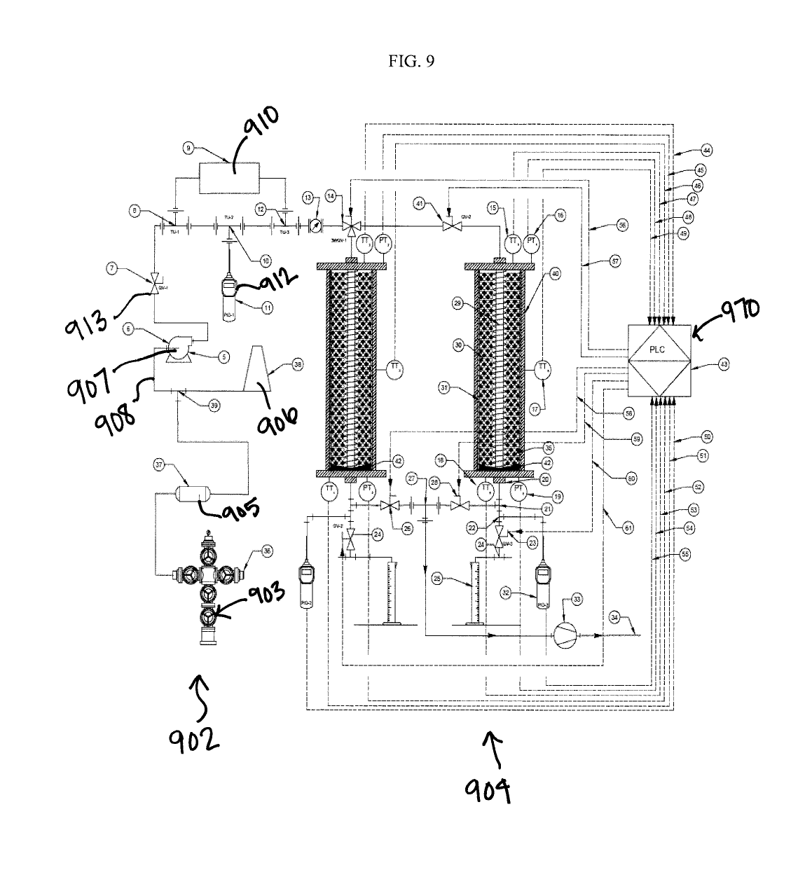

The systems and methods described above may also be suitable for use in a wellhead application. FIG. 9 is a fluid diagram of an emission control system 900 of the present disclosure for use in a wellhead application. The emission control system 900 comprises a wellhead assembly 902 and an adsorption assembly 904 connected to the wellhead assembly 902. The wellhead assembly 902 may comprise a wellhead 903 connected to a fluid source. The wellhead assembly 902 may further comprise a separator 905 in fluid communication with the wellhead 903 to separate the gas, liquid, and sand from the feed stream. Such a separator 905 may be the same or similar as one or more of the separators described in U.S. patent application Ser. No. 10/936,198 filed on Sep. 9, 2003, the content of which is hereby incorporated by reference herein in its entirety and/or U.S. Patent Application No. 62/635,900 entitled Sand Separation System filed on Feb. 27, 2018, the content of which is hereby incorporated by reference herein in its entirety. In some embodiments, the wellhead assembly 902 may further comprise a flare stack 906 in communication with the separator 905. Some of the remaining gas and/or liquid may be routed to the flare stack 906, while some of the remaining gas and/or liquid is instead routed to the centrifuge pump 907 to be processed within the adsorption assembly. The centrifuge pump 907 may be in fluid communication with the separator 905 by way of fuel line 908 for transmitting the feed stream within the system. In some embodiments, the welhead assembly 902 may comprise at least one of a gas analyzer 910 and a VOC sensor 912 for analyzing influent vapor in the feed stream. The gas analyzer 910 may be used to monitor non-VOCs. In some embodiments, a valve 813 may be positioned along the fuel line 908 between the pump 907 and the one or more of the gas analyzer 910 and the VOC sensor 912 to provide data regarding the VOCs or other compounds in the feed stream prior to adsorption. The embodiment of the adsorption assembly described above with respect to FIG. 8 is the same as the embodiment adsorption assembly 904 shown in FIG. 9.

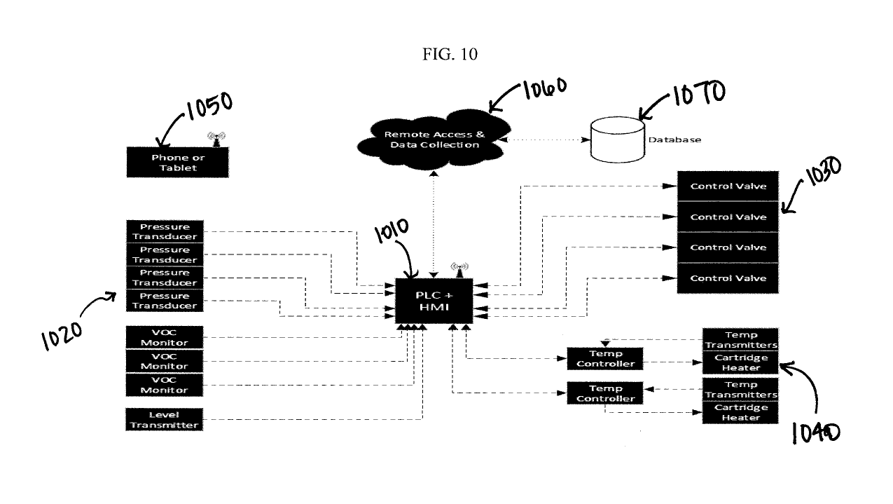

FIG. 10 shows a data flow diagram for the control unit according to one or more embodiments of the invention. The control unit 1010 may communicate with a number of sensors shown generally as 1020, a number of control valves shown generally 1030, and the cartridge heater 1040. The control unit 1010 may communicate remotely with a device 1050 such as a phone, tablet, or other computing device. In some embodiments, the control unit 1010 may communicate with a remote access and data collection module 1060 to retrieve and store data from a database 1070.

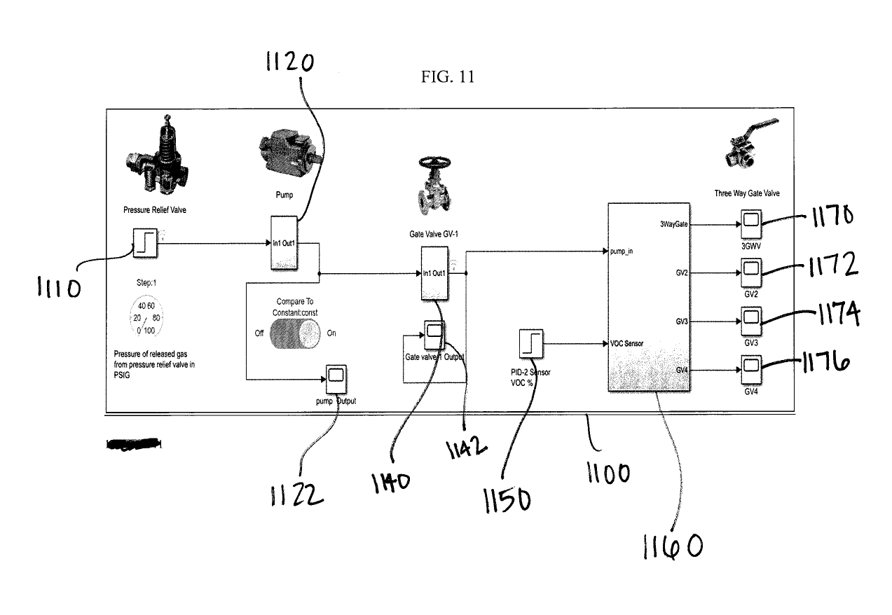

FIG. 11 shows a data block diagram of a logic system 1100 for use with the control unit comprising pressure relief valve logic 1110, pump logic 1120, check valve logic 1140, and adsorption logic 1160. A pressure relief valve logic shown generally at 1110 may provide a signal to a pump logic shown generally at 1120. The pump logic 1120 may analyze the signal and, in some embodiments, compare it to a constant. In at least one embodiment, the pump logic 1120, depending on the comparison or other signal, may output a signal to the valve logic 1140 or to a pump output 1122. In some embodiments, the valve logic 1140, depending on a signal received, may output a signal to the adsorption logic 1160. In some embodiments, based on sensor input 1150 such as the VOC sensor, a sensor signal may be provided to the adsorption logic 1160. In some embodiments, the adsorption logic 1160 sends one or more signals to one or more valves of the system to open, close, or otherwise operate the valves to control the adsorption and regeneration process. For example, the adsorption logic 1160 may send a signal to the inlet valve 1170 to the first adsorption vessel. In some embodiments, the adsorption logic 1160 may send a signal to the inlet valve 1172 to the second adsorption vessel. In some embodiments, the adsorption logic 1160 may send a signal to the outlet valve 1174 of the first adsorption vessel. In some embodiments, the adsorption logic 1160 may send a signal to the outlet valve 1176 of the second adsorption vessel.

In some embodiments, the mass of any liquid recovered following adsorption and/or desorption may be measured by reviewing the amount of effluent liquid contained in the flask. The influent concentrations in the mixture before adsorption may be used for calibration. Adsorbent extract results are based on the weight of adsorbent before adsorption and the weight of vapor desorbed, which is monitored by the gas analyzer. The mass of adsorbent recovered is based on the weight of adsorbent before extraction and the weight of extracted organic vapor recovered in liquid phase as determined by GC-MS. The mass of organic vapor recovered (in % by weight of adsorbent) may calculated as follows:

$$Percent Mass Recovered = \frac{{M}_{rc}}{( {M}_{GAC . ads} - {M}_{ads} )} 100 \%$$

where M_{rc} is the mass of adsorbate recovered, M_{adsrobent.ads} is the mass of adsorbent with adsorbate at the end of the adsorption process, and M_{ads} is the total mass of adsorbate recovered. The mass of the adsorbent in it pristine state will be (M_{adsorbent.aads}−M_{ads}), provided there is 100% removal and recovery. The amount of organic vapor adsorbed onto the adsorbent may be estimated by the amount extracted from the saturated adsorbent upon bed saturation using the expression above. The amount adsorbed may also be calculated by completing a mass balance on the reactor using the following equation:

$$Percent Mass Adsorbed = \frac{( {M}_{Ra} - {M}_{Rb} )}{( {M}_{GAC . ads} - {M}_{ads} )} 100 \%$$

where M_{Ra} is the mass of the reactor at the end of adsorption cycle, M_{Rb} is the mass of the reactor before the adsorption, and M_{adsorbentTo} is the mass of the adsorbent in its pristine state. The amount of adsorbate adsorbed by the adsorbent is determined using the equation integration area under the breakthrough curves for individual vapor components:

$$Percent mass adsorbed = {\int }_{o}^{t} \frac{{Q}_{g} ( {C}_{i} - {C}_{e} ) Δ t}{{M}_{GACo}} 100 \%$$

where Q_{g} is inlet gas flow rate during adsorption, Cᵢ and Cₑ are influent and effluent concentration i^{th} term of the adsorbate during the time step Δt.

The mass of adsorbate remaining on the adsorbent that could not be desorbed is estimated performing a mass balance around the carbon using the Equation below:

Mₐ=M_{d}+Mₗᵣ+M_{rg}

where Mₐ is the mass of adsorbate adsorbed at equilibrium, M_{d} is the mass of adsorbate desorbed in vapor phase, Mₗᵣ is the mass of adsorbate recovered in liquid phase and Mrg is the mass of adsorbate remaining in the carbon.

The mathematical model for the adsorption process may be derived from a mass balance around the control volume. The mathematical model may be based on or more of the following assumptions: that the transport phenomenon is governed by an axially dispersed plug flow model; that the adsorption bed is operated under isothermal conditions; that column pressure drop insignificant; that the ideal gas law can describe the gas phase behavior; that the adsorbent particles are spherical and homogeneous in size and density; that the carrier gas velocity is constant; and that the linear driving force is constant for the adsorbate particle during adsorption. Given these assumptions, a set of governing scale equations and appropriately scaled initial and boundary conditions are provided below:

The general mass balance expression is,

Rate of mass in −Rate of mass out±Reactions=Rate of mass accumulation

In this particular case, since the targeted adsorption is a physical phenomenon with no chemical reactions the expression becomes:

Rate of mass in −Rate of mass out=Rate of mass accumulation

Fick's law can be used because mass transport across the system boundary in the fixed bed occurs by molecular diffusion. Here the mass flux is proportional to the steepness of the concentration gradient. Therefore, the rate of mass in and out of the bed as stated will be represented by a flux term:

AεJ_{v,t}−AεJ_{v+Δv,t}=Rate of mass accumulation

Where A and ε are the cross-sectional area of the bed and bed porosity, respectively, Jv is the flux terms at the inlet of the column, and Jv+Δv,t is the flux term at the outlet of the column. The rate of accumulation term will be the sum of accumulation of adsorbate concentration in the control volume due to continuos inflow of the adsorbate vapor in the fluid phase and accumulation of adsorbate adsorbed into the pores of the adsorbent.

Therefore the right hand side (RHS) of the Equation becomes:

Rate of mass accumulation=Accumulation of adsorbate in fluid phase+Accumulation of adsorbate in solid phase which becomes:

$$A ɛ [ {J}_{v , t} - {J}_{v + Δ v , t} ] = ɛ Δ V \frac{[ {C}_{t + Δ t , v} - {C}_{t , v} ]}{Δ t} + ( 1 - ɛ ) Δ V \frac{[ {q}_{t + Δ t , v} - {C}_{t , v} ]}{Δ t}$$

Based on these simplifying assumptions, the governing equations for the gas and solid phase are established for a differential control volume.

Adsorbable species mass balance in gas phase:

$${D}_{ax , i} \frac{{\partial }^{2} {C}_{i}}{\partial {z}^{2}} - V \frac{\partial {C}_{i}}{\partial z} - \frac{\partial {C}_{i}}{\partial t} - \frac{( 1 - {ɛ}_{b} )}{{ɛ}_{b}} \frac{\partial {q}_{i , R}}{\partial t} = 0$$

Adsorbable species mass balance in the adsorbent particle:

$$\frac{\partial {q}_{i}}{\partial t} - {D}_{i} ( \frac{{\partial }^{2} {q}_{i}}{\partial {r}^{2}} + \frac{2}{r} \frac{\partial {q}_{i}}{\partial r} ) = 0$$

Gas-solid mass transfer mechanism:

$$\frac{\partial {q}_{i , R}}{\partial t} - {D}_{i} ( \frac{{\partial }^{2} {q}_{i}}{\partial {r}^{2}} + \frac{2}{r} \frac{\partial {q}_{i}}{\partial r} ) = 0$$

For the gas phase, the initial and boundary conditions are:

$$\begin{matrix}t = 0 & 0 < z < L & {C}_{i} ( 0 , z ) = 0 \\ t > 0 & z = 0 & {D}_{ax , i} \frac{\partial {C}_{i}}{\partial z} = - V ( {C}_{i , Z = {0}^{-}} - {C}_{i , Z = {0}^{+}} ) \\ t > 0 & z = L & {D}_{ax , i} \frac{\partial {C}_{i}}{\partial z} = 0\end{matrix}$$

For the solid phase:

$$\begin{matrix}t = 0 & 0 < r < R & {q}_{i} ( 0 , r ) = 0 \\ t > 0 & r = 0 & \frac{\partial {q}_{i}}{\partial r} = 0 \\ t > 0 & r = R & {D}_{i} \frac{\partial {q}_{i}}{\partial r} = k [ {C}_{i} - \frac{{q}_{i} ( t , R )}{K} ]\end{matrix}$$

The following dimensionless variables are defined and then used to transform Equations (a-i):

$$\begin{matrix}{U}_{i} = \frac{{C}_{i}}{{C}_{i , 0}} ; & ( a ) \\ {Q}_{i} = \frac{{q}_{i}}{{C}_{i , 0}} ; & ( b ) \\ x = \frac{z}{L} ; & ( c ) \\ η = \frac{r}{R} ; & ( d ) \\ τ = \frac{{D}_{i} t}{{R}^{2}} ; & ( e ) \\ {Pe}_{i} = \frac{LV}{{D}_{ax , i}} ; & ( f ) \\ {ξ}_{i} = \frac{kR}{{D}_{i} K} ; & ( g ) \\ ψ = K ( \frac{1 - {ɛ}_{b}}{{ɛ}_{b}} ) ; & ( h ) \\ {θ}_{i} = \frac{{VR}^{2} {ɛ}_{b}}{{LD}_{i} K ( 1 - {ɛ}_{b} )} ; & ( i )\end{matrix}$$

The dimensionless form of Equation (a-i) is:

Absorbable species mass balance in gas phase:

$$\frac{1}{{Pe}_{i}} {ψθ}_{i} \frac{{\partial }^{2} {U}_{i}}{\partial {x}^{2}} - {ψθ}_{i} \frac{\partial {U}_{i}}{\partial x} - \frac{\partial {U}_{i}}{\partial τ} - 3 {ψξ}_{i} ( {U}_{i} - \frac{{Q}_{i , 1}}{{K}^{′}} ) = 0$$

$$\begin{matrix}τ = 0 & 0 < x < 1 & {U}_{i} ( 0 , x ) = 0 \\ τ > 0 & x = 0 & \frac{\partial {U}_{i}}{\partial x} = - Pe ( {U}_{i , x = {0}^{-}} - {U}_{i , x = {0}^{+}} ) \\ τ > 0 & x = 0 & \frac{\partial {U}_{i}}{\partial x} = 0\end{matrix}$$

Adsorbable species mass balance in the adsorbent particle:

$$\frac{\partial {Q}_{i}}{\partial τ} - ( \frac{{\partial }^{2} {Q}_{i}}{\partial {η}^{2}} + \frac{2}{η} \frac{\partial {Q}_{i}}{\partial η} ) = 0$$

$$τ = 0 \qquad 0 < η < 1$$

$${Q}_{i} ( 0 , η ) = 0$$

$$τ > 0 \qquad η = 0 \qquad \frac{\partial {Q}_{i}}{\partial η} = 0$$

$$τ > 0 \qquad η = 1 \qquad \frac{1}{K} \frac{\partial {Q}_{i}}{\partial η} = {ξ}_{i} [ {U}_{i} - \frac{{Q}_{i} ( τ , 1 )}{{K}^{′}} ]$$

The set of coupled partial differential equations may be used to describe the adsorption vessel and may be solved using the numerical method of lines (Schiesser & Griffiths, 2009). The spatial discretization may be performed using second order central differencing with 21 equally spaced axial nodes. After domain discretization, the PDEs may be reduced to a set of ordinary differential Equations (ODEs). The set of ODE's may be solved using a program such as a variable step solver that uses numerical differentiation formula or Gears method, like the MATLAB inbuilt ODE solver—ode15s.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. An emission control system, comprising:
a plurality of vessels, each vessel an adsorbent arranged in the vessel;
a valve system for selectively routing a feed stream to a selected vessel of the plurality of vessels thereby establishing an online vessel and one or more offline vessels; and
a control unit configured for monitoring breakthrough of the online vessel and for controlling the valve system to route the emission an offline vessel upon breakthrough being determined in the online vessel, the routing establishing a new online vessel.

2. The system of claim 1, wherein the control unit is further configured to initiate a regeneration cycle for the formerly online vessel.

3. The system of claim 1, wherein the feed stream is emission gas.

4. The system of claim 1, wherein the vessel further comprises a heating element configured for selective heating of the adsorbent.

5. The system of claim 1, wherein the valve system comprises an inlet valve in fluid communication with a feed stream source, a first vessel, and a second vessel.

6. The system of claim 5, wherein the inlet valve is positioned near the top of the first vessel.

7. The system of claim 1, wherein the valve system comprises an exit valve.

8. The system of claim 7, wherein the exit valve is positioned near the bottom of the first vessel.

9. The system of claim 1, wherein the control unit is a programmable logic controller.
